(19) United States
(12) Patent Application Publication
(10) Pub. No.: US 2015/0265490 A1
(43) Pub. Date: Sep. 24, 2015

(54) WALKER COMPRISING MECHANISM FOR ASSISTING A USER IN STANDING AND SITTING OPERATIONS

(71) Applicants: CONSEJO SUPERIOR DE INVESTIGACIONES CIENTÍFICAS (CSIC), Madrid (ES); UNIVERSIDAD POLITÉCNICA DE MADRID, Madrid (ES)

(72) Inventors: Manuel Javier Cestari Soto, Arganda Del Rey (Madrid) (ES); Daniel Sanz Merodio, Arganda Del Rey (Madrid) (ES); Juan Carlos Arévalo Reggeti, Arganda Del Rey (Madrid) (ES); Elena García Armada, Arganda Del Rey (Madrid) (ES)

(21) Appl. No.: 14/434,817

(22) PCT Filed: Oct. 7, 2013
(86) PCT No.: PCT/ES2013/070689

§ 371 Date: Apr. 10, 2015

(30) Foreign Application Priority Data
Oct. 11, 2012 (ES) P201231567

(51) Int. Cl. A61H 3/04

(52) U.S. Cl. CPC A61H 3/04; A61H 2003/007

(57) ABSTRACT

A walker (1) with a mechanism for assisting a user (21) in standing and sitting operations, comprising a support structure equipped with movement means (2,3), a device (20) for securing the user to the walker and a system for blocking the movement means, wherein the support structure comprises at least one pivoting arm (14) that guides the device (20) for securing the user (21), a guide support (11) that is fixed to the walker (1) and guides the arm (14), and a control module (15) that controls the system for blocking the movement means (2,3) and which comprises means for selecting a working mode of the walker, by selecting from between “walking mode” and “sitting/standing mode”.

### OBJECT OF THE INVENTION

The present invention relates to a walker that incorporates a mechanism for assisting a user in standing and sitting operations. Said walker, which may be adjusted in size to the user, comprises an active or passive mechanical device that enables the users to sit down, whilst keeping the walker fixed, in order to guarantee a high level of stability due to the two degrees of freedom it is provided with. Said degrees of freedom are provided to the user via a bar that pivots with respect to the walker and that moves along the length of a rail and a linear sliding guide, which is connected to the device for securing the user. Furthermore, the walker is considered to be intelligent, since it is provided with electronic means to manage a variety of parameters that determine the operation thereof, such as the speed of the user when walking or the weight thereof, and it carries out braking or sitting and standing aid operations for the user depending on these parameters.

The present invention falls within the mechanical engineering sector, and may be of particular use in the industrial field of manufacturing assistive mobility devices and apparatuses for the elderly or people with disabilities, in the rehabilitation field and biped robotics.

### BACKGROUND OF THE INVENTION

Walkers are devices that increase the support base and ensure greater stability and balance for the user. Today, their use represents an alternative that contributes to the improvement of quality of life and the health of individuals with walking problems, difficulty in supporting their own weight and heart problems, among other conditions. The movement of a walker by a user is achieved through their locomotion skills, whether they are natural or externally assisted. The use of walkers promotes the exercise of the user's muscles, thus preventing the rapid deterioration linked to wheelchairs and providing the user with psychological benefits of self-esteem.

Typical commercial walkers that support the weight of the user are primarily aimed at rehabilitation purposes, and only enable it to be used in one mode, typically walking, thus making it impossible to be used to carry out everyday activities or for the user to be included in a normal social environment due to being limited to a single mode. Those devices that include mechanisms that make it possible to sit, stand or do muscle toning exercises are characterised by having large structures or systems with a rigid configuration that do not enable the devices to be adapted depending on the requirements of the user. The document U.S. Pat. No. 6,733,018 B2 presents a practical device that incorporates a system with pivoting bars that draw an arc at the joining point between the user and walker and the pivot point. However, although this device offers the user the possibility of sitting and standing, it requires the wheels of the walker to move on the horizontal plane in order to compensate the natural movement when sitting down, which does not have a constant radius, which means that the sitting and standing operations are unsteady and even dangerous for certain users. Similarly, in the case of blocking the wheels of the device, this restriction of movement causes an unnatural movement in the body of the user.

Furthermore, the incorporation of intelligent systems to control walkers, which are adapted to the needs of the user and which contribute to the use of these devices to carry out everyday activities safely, even without the need for support staff, thus providing the user with greater independence, is still in a developmental stage and generally does not incorporate many of the everyday requirements or are not specialised for a particular operation.

In addition to the foregoing, there are many different types and models of walker that may be classified according to their operations, adaptability features and programmable or automatic operations. However, there are currently very few that include sufficient elements that enable users with greater assistance requirement a high level of integration into society.

The document ES1053675U presents a conventional four-wheeled walker with a folding seat that enables the user to sit on the walker by their own. The use of four-wheeled systems is known to enable continuity when the user walks and eliminates the need for the user to lift the walker in order to take the next step, thus reducing the physical demand.

The document U.S. Pat. No. 7,150,722 B1 describes a walker designed to facilitate walking by a disabled person. This device requires the intervention of a helper or carer to secure the user to the walker and it does not enable them to sit once it is being used.

The document U.S. Pat. No. 8,151,812 B2, similarly to the aforementioned U.S. Pat. No. 6,733,018 B2, describes a walker that is capable of supporting a portion of the user's weight, whilst also having active mechanisms with one degree of freedom that enable the user to sit using the walker. A pivoting bar mechanism coupled to the user enables the sitting and standing movement, but by having a single degree of freedom, the walker must move horizontally to achieve the appropriate movement, thus not ensuring the user's safety without the presence of a helper. The bar system uses compressed springs to facilitate lifting the weight and the wheels have a brake, which is activated normally, typically being located on the wheels of the walker.

The document “Hirata, Y. Muraki, A. Kosuge, K. ‘Standing Up and Sitting Down support Using Intelligent Walker based on Estimation of User States’ IEEE international Conference on Mechatronics and Automation”, describes a control system for a walker with wheels to support a user, based on the position of the body in relation to a reference in the walker, enabling the user to control turns or brake the walker via an intelligent braking system.

The document “Martins, M., Santos, M., Frizera-Neto, A & Ceres, R. ‘Assistive Mobility devices focusing on Smart Walkers: Classification and review’, Robotics and Automation Systems 60 (2012) pp 553-560”, describes intelligent technologies applied to walkers to assist the elderly or people with motor disabilities. The brake control system, the need for it to be adaptable to the user and the possibility that the device supports all or part of the user's weight must be highlighted.

### DESCRIPTION OF THE INVENTION

The present invention relates to a walker, which may be adjusted in size, provided with intelligent operations to assist the user and which enables them to sit and stand whilst being attached to the walker, thus enabling it to be used to do everyday activities and guaranteeing an appropriate stability for those users that have greater motor limitations. Thus, said walker, which may be adjusted in size to the user, has intelligent mechanisms integrated into a control system that provide the user with greater security, as well as the possibility of sitting and standing more independently and securely given the greater stability provided by the device.

Thus, the present invention relates to a walker with a mechanism for assisting a user in standing and sitting operations, comprising a support structure equipped with movement means, a device for securing the user to the walker and a system for blocking the movement means. Said support structure of the walker in turn comprises:
at least one pivoting arm that pivots at one of the ends thereof with respect to the support structure via a pivot element and which comprises a guide for the movement of the device for securing the user along the length of the arm;
at least one guide support, which is fixed to the support structure and equipped with movement stops at the ends thereof that limit the movement of the pivoting arms on the longitudinal axis of the walker. Each one of said guide supports is located in correspondence to one of the pivoting arms; and,
a control module that controls the system for blocking the movement means and which comprises means for selecting a working mode of the walker, by selecting from between “walking mode”, “support mode” and “sitting/standing mode”.

In a particular embodiment of the walker, object of the present invention, the pivot element of the pivoting arms comprises a sliding piece that slides via sliding means that may be compressed between a regulatable lower stop and a regulatable upper stop, the articulation that joins the pivoting arm to the pivot element being situated on the sliding piece. These tilting elements are generally found situated on the upper end of the support structure itself of the walker.

In another particular embodiment of the present invention, the aforementioned sliding means comprise means for regulating the compression in order to regulate a weight of the user that is supported by the support structure of the walker.

In another particular embodiment of the present invention, the walker is provided with fixing means of at least one pivoting arm where the fixing means are integrated into at least one guide support and fixing means of the device for securing the user in the guide of the at least one pivoting arm. These fixing means keep the pivoting arm fixed and in a vertical position when they are active, in such a way that they restrict the movement of the user by keeping them upright. Thus, when the user selects either the walking mode or the support mode of the walker and once the user is standing, these fixing means are activated, thus keeping the user on the sagittal plane of the walker. Moreover, it has been provided that these fixing means can be activated or deactivated manually or automatically, in such a way that in the case of being provided with automatic activation, the control module of the walker is provided with electric means or pneumatic means in order to do so. Therefore, the inclusion of electrical wiring, pneumatic distribution pipes or solenoid pins has been provided in the support structure, all these elements being controlled by the control module.

In another particular embodiment of the present invention, the walker has mechanical actuators inside the guide support that assists the user in standing and sitting operations. The actuators act on the free end of the pivoting arms, in such a way that, by pushing and separating said end from the sagittal plane of the walker, they help in the sitting operation, whilst when the end is pulled, bringing it closer to the sagittal plane, they help in the standing operation.

In another particular embodiment of the present invention, it has been provided that the walker has mechanical actuators or similar, for example conventional actuators, situated between the support structure and the lower stop of the tilting element. Said actuators support a portion of the user's weight both in the sitting and standing operations and when the walker is working in the walking or support mode. Thus, the actuator that is situated between the support and the lower stop of the tilting elements regulates the position of the lower stop for the pre-compression of the means for regulating the compression of the sliding means.

In another particular embodiment of the present invention, the control module comprises means for controlling the speed of the movement means in order to block the movement means.

In another particular embodiment of the present invention, the support structure comprises telescopic elements integrated into the structure itself to regulate the height and the area occupied on the surface where the walker rests.

In another particular embodiment of the present invention, the device for securing the user comprises securing bars for the torso and femur that are adjusted to the user via adjustable straps.

### BRIEF DESCRIPTION OF THE FIGURES

FIG. 1.—Shows a perspective view of an exemplary embodiment of the walker, object of the present invention, which has the pivoting arms in a vertical position, corresponding to the walking or support mode for the operation of the walker.

FIG. 2.—Shows another perspective view of the walker shown in the previous figure, where the rotation of the arms that enables the walker to operate in the sitting and standing mode is illustrated.

FIG. 3.—Shows a side view of a natural sitting sequence using the walker shown in FIGS. 1 and 2, which shows how the two degrees of freedom of the system enable the user's centre of mass to be kept on the vertical axis and without moving the walker.

FIG. 4.—Shows a detailed perspective view of an exemplary embodiment of the control box where the control module, object of the invention, is integrated.

FIG. 5.—Shows a perspective view of an exemplary embodiment of the walker with a user coupled to it.

FIG. 6.—Shows a detail view of an exemplary embodiment of the device for securing the user to the walker.

FIG. 7.—Shows a detail view of the tilting elements on which the pivoting arms pivot with respect to the support structure of the walker.

FIG. 8.—Shows a detailed perspective view of a particular embodiment of the wheels that are coupled to the lower portion of the walker and the elements that are fixed to it.

FIG. 9.—Shows a view of an exemplary embodiment of the mechanisms for assisting the user in standing and sitting operations, which are integrated into the structure of the walker and the guide supports.

### DESCRIPTION OF VARIOUS EXEMPLARY EMBODIMENTS OF THE INVENTION

A description of various exemplary embodiments of the invention is carried out below by way of illustrative and non-limiting examples, which refers to the numbering adopted in the figures.

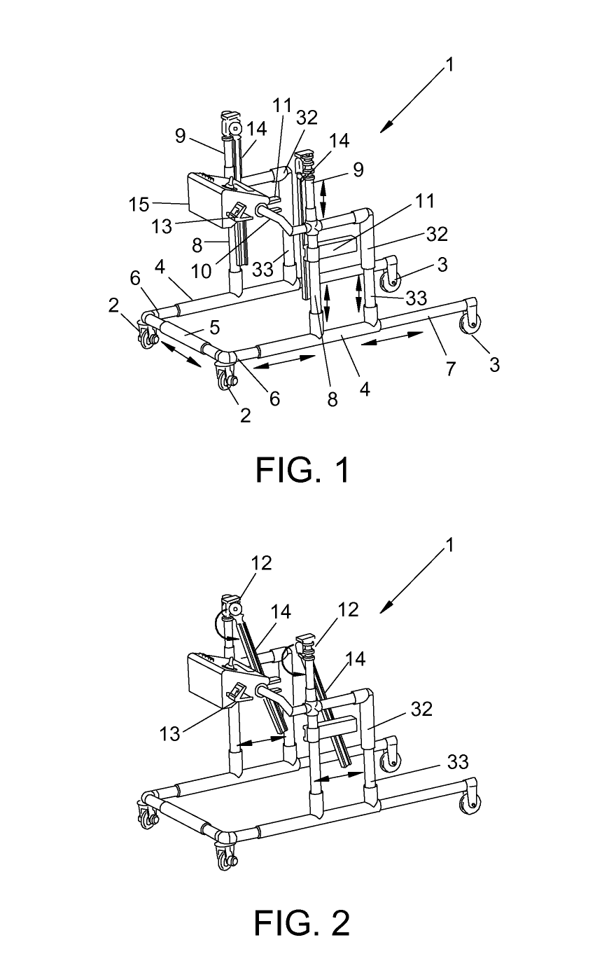

FIGS. 1 and 2 show perspective views of the same exemplary embodiment of the walker (1), object of the invention. In this exemplary embodiment, the adaptable support structure of the walker (1) is made up of tubular aluminium bars (6,7) inserted in hollow aluminium connections (4,5) for a desired measurement of the base of the structure and adjusted either by a pressure device or tamper screws. The tubular aluminium bars (8,9) are fitted together to adjust the desired height of the walker (1) and they are inserted into the vertical support of the hollow connections (4). Thus, it is a walker (1) structure that contains telescopic structures (6,7,8,9,10,32) to regulate the size where the bars of the chassis (4,5,8,18,32) are extended or retracted in order to regulate the height of the walker (1) and modify the support area in the event that greater stability is needed. The vertical structure (8,9) provides stability to the user on the sagittal plane, the user being joined to the structure through a set of elements (12,14,31).

The walker (1) enables an operation mode that is selected from between walking mode, support mode and a standing/sitting mode. Specifically, FIG. 1 shows the walker (1) arranged in the walking or support mode. In both cases, the pivoting arms (14) are situated so as to correspond to the vertical structure (8,9) and fixed to the guide supports (11) via a number of first fixing pieces (34) and the device (20) for securing the user (21) to the walker (1) is also fixed to the pivoting arms (14) via a number of second fixing pieces (35). This securing device (20), generally a harness, is placed on the user before he is coupled to the walker (1), such that said walker is provided with means for coupling and decoupling the means for securing the user once these have been placed on the aforementioned user. As for FIG. 2, it shows the walker arranged in the standing/sitting mode, where the pivoting arms (14) and the securing device (20) have been freed from the fixing pieces (34,35) respectively, thus enabling the user (21) to sit and stand without the walker (1) moving in a longitudinal direction.

Moreover, the walker (1) is provided with a control module arranged inside a control box (15) that contains a series of electronic elements and an energy source to supply the power required by the walker (1). Said control box (15) enables the different operation modes of the walker to be activated through actionable buttons. It is also provided with a brake (13) for blocking the walker (1). The join of the pivoting arm (14) to the walker (1) is carried out through a sliding carriage (2) that guarantees the correct pattern of movement for the user during sitting and standing. A set of front bars (10,18) support the control box (15) that contains the energy source of the system, the manual brake (13) and the actionable buttons (17). The wiring of the control system is distributed throughout the structure inside conduits in the bars thereof in order to connect the brakes of the wheels (2,3) and the wires with the speed data signal of the same.

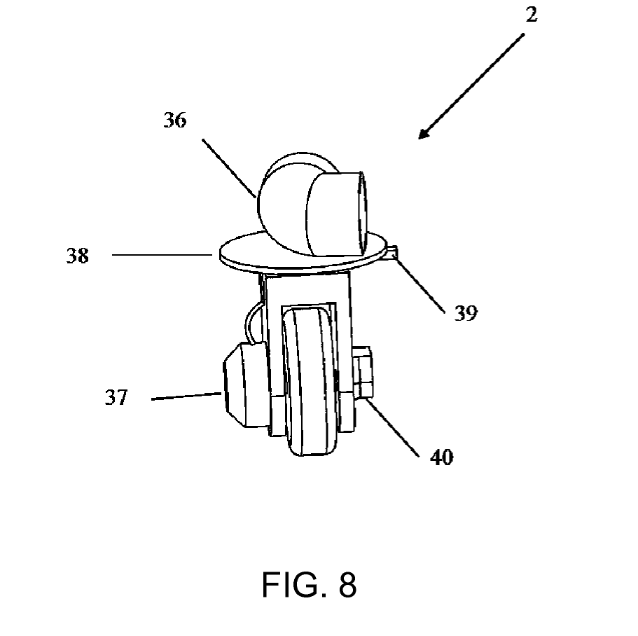

The front wheels (2) are coupled to the base of the structure by means of the union elbow (36) thereof, which may be seen in more detail in FIG. 8, and the back wheels (3) are coupled into the ends of the back tubular bars (7) of the base of the walker (1). Note that in this particular embodiment, the use of idler wheels (2) in the front portion of the walker and fixed wheels (3) in the rear portion have been provided. However, any combination of the same may be established depending on the requirements.

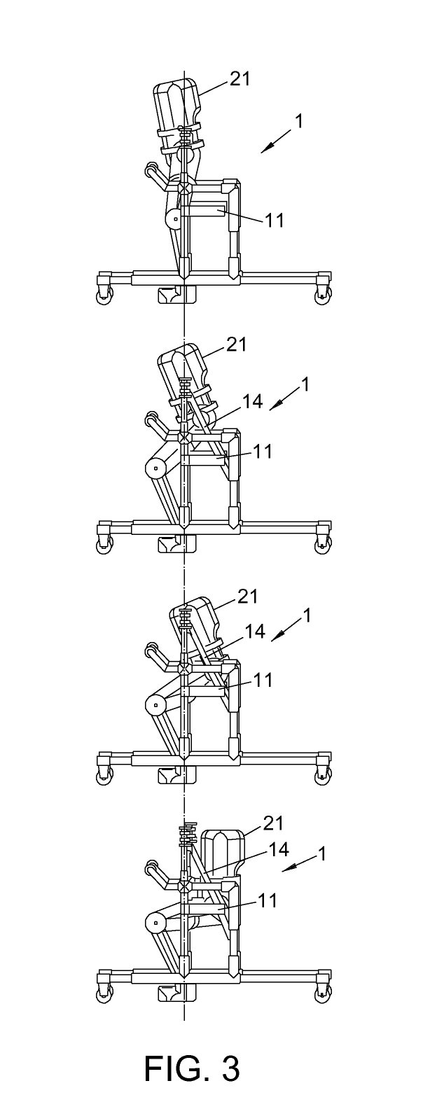

As for FIG. 3, it shows the sitting operation of a user (21) via the walker (1), object of the present invention. Note how during the different stages shown, the user's (21) centre of gravity remains stable, which means that the walker does not move on the longitudinal axis. By preventing this longitudinal movement, the user is given greater security when carrying out standing and sitting operations.

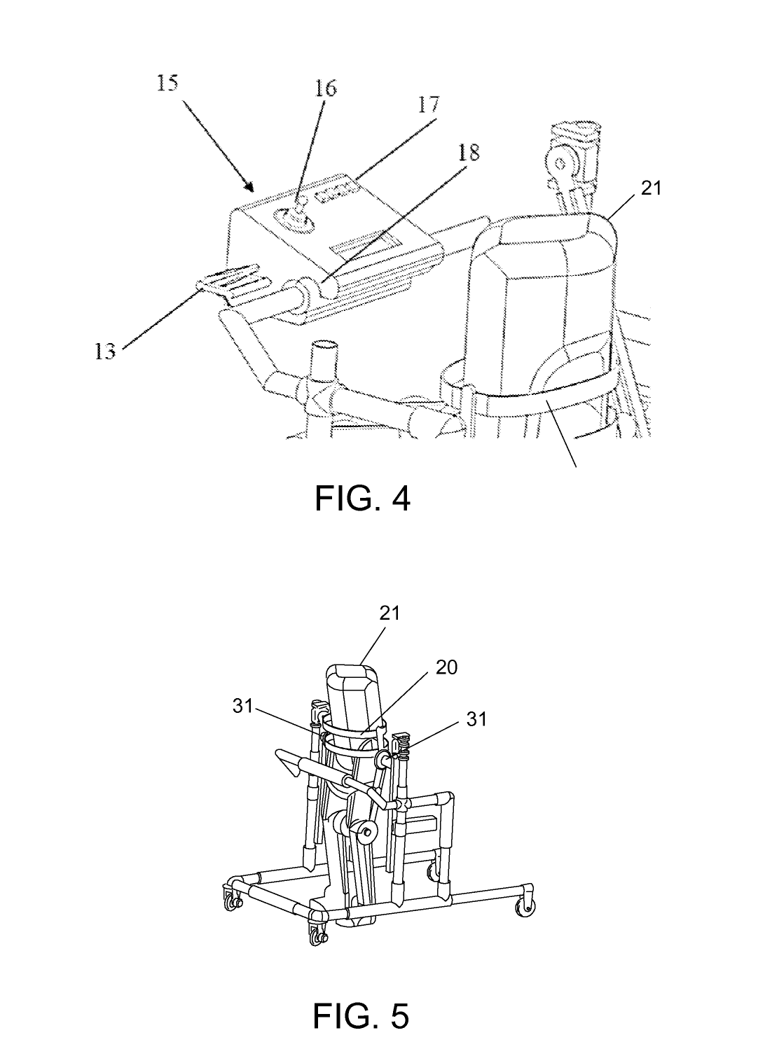

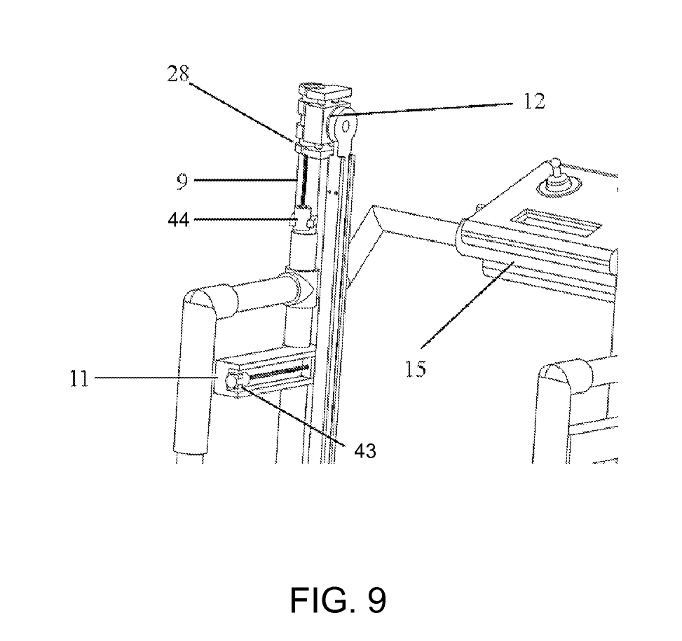

FIG. 4 shows a detailed view of an exemplary embodiment of the control box (15). Said control box (15), in which the control system of the walker is located, has a usually active brake (13) that the user may reach, that commands the blocking of the wheels (2,3), a controller (16) that activates the walking, support or sitting/standing mode, thus activating the pins and a possible actuated standing system (see FIG. 9). This control system has a programmed speed profile that guarantees user comfort, without the abrupt speed changes and guaranteeing zero speed when the final points of the operation have been reached, whether the user is upright or seated. Furthermore, it includes a series of actionable buttons (17) that have operations such as regulating brakes, graduating the support system, etc. The control system automatically registers the speed of the wheels and, in accordance with the programming, commands a speed emergency braking system and operation braking. Emergency braking is activated when a previously established speed of the walker is exceeded. The operation braking is linked to the walking speed of the user, this being an intermittent braking that, when the user takes a step, whilst their leg is in the air, the wheels are blocked, thus guaranteeing the stability thereof, and just after the heel touches the ground, the wheels are released so that the user can move forwards. Thus, this type of braking is linked to the walking rate of the user.

FIG. 5 shows a perspective view of the user placed in and fixed to the walker via a harness (20). Said harness (20) is in turn fixed to the walker (1) via a number of elements (31) that are guided along the sliding rail (33) coupled to the pivoting arm (14).

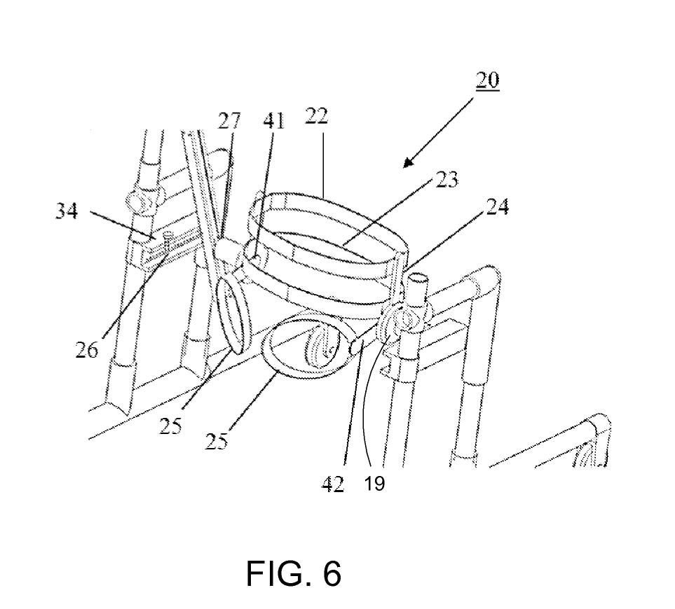

FIG. 6 shows an exemplary embodiment of the system for securing the user (21) to the walker (1), which is adjustable to the torso and legs of the user by means of straps and is connected to the guide (33) of the pivoting arm (14) by means of a slider with a projection screwed into the securing system. Said join between user and walker is carried out through a harness type device (20), with support bars (24) for the torso, which are adjusted by straps (22, 23), and a number of bars (42) at femur height, which are adjusted at the legs by adjustable straps (25). These bars (42) at femur height pivot with respect to the support bars (24) for the torso via both rotation discs (19). At the point of rotation of the hips (41), the bars pivot between each other, and from this shaft a projecting structure (31) must fit into the guide (33) of the pivoting bar (14), joining the user to the walker through a fixing point (27). This fixing point slides along the length of the guide (33) and together with the rotation of the pivoting arm (14) provide the freedom to adapt to different user (21) sitting, bending or standing movements. Thus, the joining point (27) is provided with two degrees of freedom on the sagittal plane.

When an actionable element (17) is activated, and once the pins (34,35) are unblocked, the possible actuators (44) that support the weight of the user (21) are activated, whilst the latter may sit down with a natural movement that is adaptable to their conditions due to the degrees of freedom of the system provided by the pivoting arms (14) and the joining point with the securing system (27) coupled on a sliding rail (33) (see FIG. 3).

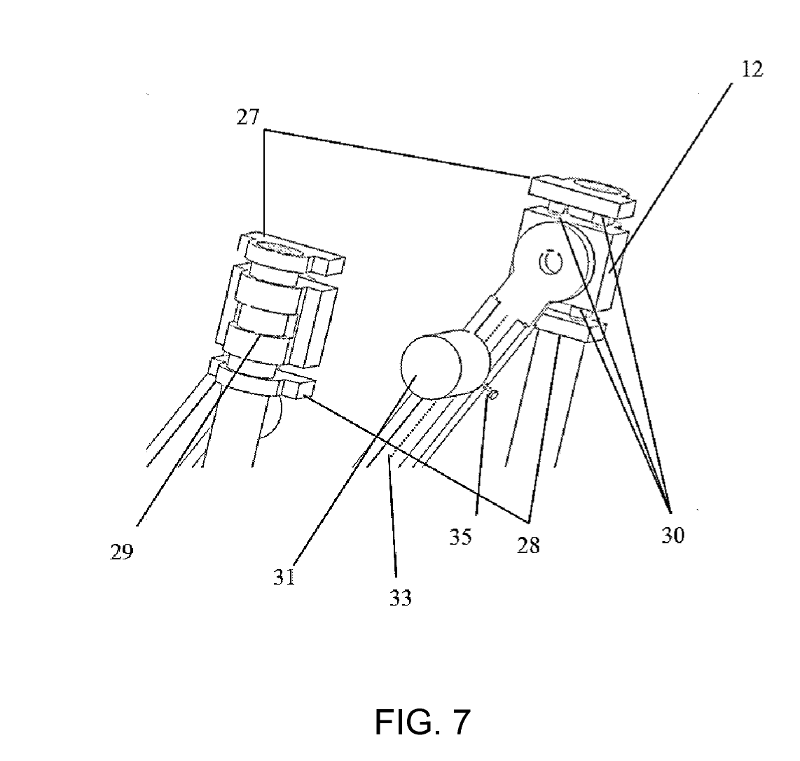

FIG. 7 shows a detailed view of the tilting element of the pivoting arm (14). The stops (27, 28) are fixed by pressure into the upper portion of the vertical bar (9), the adaptable connections (30) and the sliding rail (12) being adjusted between said stops, thus enabling a maximum vertical movement of +2 cm for a force equivalent to half the user's weight. The pivoting arms (14) pivot on the joining point with the sliding rail (12) through a joint with a bearing and fixed with a retaining ring. The pivoting arms (14) are connected to the guide support (11) through a slider in the conduit thereof (26). In turn, the joint element (31) of the means (20) for securing the user (21), generally a waist harness, is moved through the guide (33) of the pivoting arms (14).

FIG. 8 shows a detailed view of the wheels (2) that are coupled to the front portion of the structure of the walker (6) by means of an elbow type attachment (36). They may rotate on a shaft (38) like idler wheels or be blocked by embedding a mechanical stop (39) in the structure of the walker. The braking system (39) is connected to the control box (15) and regulates the blocking of the wheels. A speed regulator (40) connected to the control system enables the movement of the walker to be analysed and enables the speed signal coming from the speed regulator to be integrated into the control system of the walker in order to execute the actions necessary when faced with expected and unexpected movements.

FIG. 9 shows an exemplary embodiment of the invention in which mechanical actuators have been incorporated in the guides of the guide support, which help the user in standing operations, and in the support structure of the walker that assist the regulation operation of the device for securing the user.

With regards to the operation modes of the walker, object of the present invention, the following have been provided:

a) Walking mode, (see FIG. 1) the pivoting arm (14) is at its minimum angle relative to the vertical (9) and the pin (34) is activated, thus blocking the rotations of the pivoting arm (14). The securing piece (31) that connects the guide (33) to the user (21) or the harness (20) thereof is fixed by the pin (35) (see FIG. 7).

In order to enable the user's centre of mass to move naturally, the sliding piece (12), on which the pivoting arms (14) rotate, enables a vertical movement due to the fact that it is connected to the upper (27) and lower (28) stops by means of adaptable and regulatable elements (30) (see FIG. 7). This vertical movement, combined with the movement of the walker (1), results in the curve pattern described by the centre of mass of an individual when walking.

b) Support mode, the regulation of the stops (27,28) that connect the sliding piece (12) enable the compression of the adaptable supports (30) to be regulated, thus increasing or decreasing the weight of the user (21) supported by the walker (1). This operation may be manual, by regulating the position of the stop (28) and for that matter, the load to be supported by the spring elements, or automatic, by means of a mechanical actuator (44) attached to the lateral bars of the walker (9) in the automated configurations of the walker (see FIG. 9).

c) Sitting/standing mode, the pins (34, 35) are deactivated, thus enabling the pivoting bar (14) to rotate on the shaft of the sliding piece (12) and, guided by the support piece (11), this movement along with the possibility that the contact (27) may slide along the length of a guide (33), enable the user (21) to sit or stand being joined to the walker, without the need to compensate for the movement of the wheels (2, 3) (see FIG. 3). The sitting/standing operation may be carried out by the motor means of the user or using the mechanical actuators (43) in the linear guides that control the rotation of the pivoting arms (14), which enables the user to reach the sitting or standing position in a controlled and safe manner (see FIG. 9).

1. A walker with a mechanism for assisting a user in standing and sitting operations, comprising a support structure equipped with movement means, a device for securing the user to the walker and a system for blocking the movement means, characterised in that the support structure comprises:
at least one pivoting arm that pivots at one of the ends thereof relative to the support structure via a pivot element and which comprises a guide for the movement of the device for securing the user along the length of the arm;
at least one guide support, which is fixed to the support structure and equipped with movement stops at the ends thereof that limit the movement of the pivoting arm on the longitudinal shaft of the walker; and,
a control module that controls the system for blocking the movement means and which comprises means for selecting a working mode of the walker, by selecting from between walking mode, support mode and sitting/standing mode.

2. The walker with a mechanism for assisting a user in standing and sitting operations, according to claim 1, characterised in that the pivot element of the at least one pivoting arm comprises a sliding piece that slides via sliding means that may be compressed between a regulatable lower stop and a regulatable upper stop, the articulation that joins the pivoting arm to the pivot element being on the sliding piece.

3. The walker with a mechanism for assisting a user in standing and sitting operations, according to claim 2, characterised in that the sliding means comprise means for regulating the compression in order to regulate a weight of the user that is supported by the support structure of the walker.

4. The walker with a mechanism for assisting a user in standing and sitting operations, according to claim 1, characterised in that it comprises fixing means of the at least one pivoting arm integrated in the at least one guide support and fixing means of the device for securing the user in the guide of at least one pivoting arm, in order to keep the user incorporated when the walking or support mode of the walker has been selected.

5. The walker with a mechanism for assisting a user in standing and sitting operations, according to claim 1, characterised in that it comprises mechanical actuators inside the guide support to assist the user in standing and sitting operations.

6. The walker with a mechanism for assisting a user in standing and sitting operations, according to claim 4, characterised in that the guide of the pivoting arm comprises fixing means of the fixing device to the upper portion of the arm.

7. The walker with a mechanism for assisting a user in standing and sitting operations, according to claim 1, characterised in that the control module comprises means for controlling the speed of the movement means for braking and blocking the movement means.

8. The walker with a mechanism for assisting a user in standing and sitting operations, according to claim 1, characterised in that it comprises actuators.

9. The walker with a mechanism for assisting a user in standing and sitting operations, according to claim 1, characterised in that the securing structure comprises telescopic elements integrated into the structure of the walker to regulate the height and the area the walker occupies on the surface where the walker rests.

10. The walker with a mechanism for assisting a user in standing and sitting operations, according to claim 1, characterised in that the device for securing the user comprises securing bars for the torso and femur that are adjusted to the user via adjustable straps.

11. The walker with a mechanism for assisting a user in standing and sitting operations, according to claim 2, characterised in that it comprises fixing means of the at least one pivoting arm integrated in the at least one guide support and fixing means of the device for securing the user in the guide of at least one pivoting arm, in order to keep the user incorporated when the walking or support mode of the walker has been selected.

12. The walker with a mechanism for assisting a user in standing and sitting operations, according to claim 3, characterised in that it comprises fixing means of the at least one pivoting arm integrated in the at least one guide support and fixing means of the device for securing the user in the guide of at least one pivoting arm, in order to keep the user incorporated when the walking or support mode of the walker has been selected.

13. The walker with a mechanism for assisting a user in standing and sitting operations, according to claim 2, characterised in that it comprises mechanical actuators inside the guide support to assist the user in standing and sitting operations.

14. The walker with a mechanism for assisting a user in standing and sitting operations, according to claim 3, characterised in that it comprises mechanical actuators inside the guide support to assist the user in standing and sitting operations.

15. The walker with a mechanism for assisting a user in standing and sitting operations, according to claim 4, characterised in that it comprises mechanical actuators inside the guide support to assist the user in standing and sitting operations.

16. The walker with a mechanism for assisting a user in standing and sitting operations, according to claim 5, characterised in that the guide of the pivoting arm comprises fixing means of the fixing device to the upper portion of the arm.

17. The walker with a mechanism for assisting a user in standing and sitting operations, according to claim 2, characterised in that the control module comprises means for controlling the speed of the movement means for braking and blocking the movement means.

18. The walker with a mechanism for assisting a user in standing and sitting operations, according to claim 2, characterised in that it comprises actuators.

19. The walker with a mechanism for assisting a user in standing and sitting operations, according to claim 2, characterised in that the securing structure comprises telescopic elements integrated into the structure of the walker to regulate the height and the area the walker occupies on the surface where the walker rests.

20. The walker with a mechanism for assisting a user in standing and sitting operations, according to claim 2, characterised in that the device for securing the user comprises securing bars for the torso and femur that are adjusted to the user via adjustable straps.
